(19) United States
(12) Patent Application Publication
(10) Pub. No.: US 2023/0134269 A1
(43) Pub. Date: May 4, 2023

(54) System And Method For Call And Contact Management

(71) Applicant: Yoram Haim ZER, Ra'anana (IL)

(72) Inventor: Yoram Haim ZER, Ra'anana (IL)

(21) Appl. No.: 18/049,923

(22) Filed: Oct. 26, 2022

Related U.S. Application Data
(60) Provisional application No. 63/271,800, filed on Oct. 26, 2021.

(51) Int. Cl. H04M 1/27457; H04M 3/42

(52) U.S. Cl. CPC H04M 1/27457; H04M 3/42221

(57) ABSTRACT

The present invention provides a contact management application, implemented on a smart phone, said application comprised of:
Call tracker module for identifying end of call;
Voice recording module, which is configured to be activated upon identifying end of call, for recording short message by the smart phone user, wherein the recording is activated for predefined time period or upon receiving an indication from the user to end the recording;
Contact management module for creating automatically new contact record upon identifying end of call in case the call number is not in the contact list of the smart mobile phone, wherein the contact record includes at least: the call number, time and date of the call and the recorded short message.

### FIELD OF THE INVENTION

The present invention relates generally to managing of phone calls and contacts.

### Background

### SUMMARY OF THE INVENTION

The present invention discloses a call management application, implemented on a smart phone, implemented by plurality of modules comprising one or more processors, operatively coupled to non-transitory computer readable storage devices, comprising the following modules:
call tracker module for identifying end of call;
call enrichment module, which is configured to be activated upon identifying start of call configured for uploading a first popup screen, enabling the user enter messages during the call and/or classify call by label and/or assign call log to predefined group of users;

call log management module configured to save all information collected by the enrichment module is association with the specific call log, wherein for each call log record includes the entered messages and/or label and or the assigned group.

According to some embodiments of the present invention the call management the contact management module enables to share contact record between users which have established group relations in between.

According to some embodiments of the present invention each contact record has a group field and or sub group field, such as all records of specific category/sub category are shared between users which are part of predefined group;

The present invention discloses a contact management application, implemented by plurality of modules comprising one or more processors, operatively coupled to non-transitory computer readable storage devices,
Call tracker module for identifying end of call;
Voice or text recording module, which is configured to be activated upon identifying end of call, for recording short message by the user, wherein the recording is activated for predefined time period or upon receiving an indication from the user to end the recording;
Contact management module for creating automatically new contact record upon identifying end of call in case the call number is not in the contact list of the smart mobile phone, wherein the contact record name is based on the recorded message and include at least: the caller number, time and date of the call and the recorded short message.

According to some embodiments of the present invention the voice recording module is configured to record during the call upon user activation at the time of the call, maintaining only partial part of the call for predefined period before the user activated the recordation till the point in time of the activation.

According to some embodiments of the present invention the partial recording is implemented by recording the whole call session and tagging the time slot the user selected to record, wherein At the end of the call or later the selected time slot is extracted from the recorded call session and saved in association with record of the call and record of the contact name.

According to some embodiments of the present invention before starting the recording prompting, the user with voice or text message indicating the recording has started. The present invention discloses a call management application, implemented on a smart phone, by plurality of modules comprising one or more processors, operatively coupled to non-transitory computer readable storage devices:
call tracker module for identifying start of call;
call management module, which is configured to be activated upon identifying start of call, enabling the user to enter text or voice message #;
contact management module for updating call log or contact record with entered text or voice message.

According to some embodiments of the present invention the call management module is further configured to define contact by determining group association during the call session.

According to some embodiments of the present invention the Call management module is further configured to define contact by determining one or more label associated with the contact or specific call during the call session.

According to some embodiments of the present invention the Call management module is further configured to enable sharing documents between groups members.

According to some embodiments of the present invention the application is further configured to select documents to be accessed by cloud database to all group members by providing automatic authority to group member to access the selected documents

According to some embodiments of the present invention in case of unknown caller name creating new contact based on recording text by identifying names or text entered during the call or after the call ended.

The present invention provides a contact management application, implemented by plurality of modules comprising one or more processors, operatively coupled to non-transitory computer readable storage devices, comprising the following modules:
Call tracker module for identifying end of call;
Voice recording module, which is configured to be activated upon identifying end of call, for recording short message by the smart phone user, wherein the recording is activated for predefined time period or upon receiving an indication from the user to end the recording;
Contact management module for creating automatically new contact record upon identifying end of call in case the call number is not in the contact list of the smart mobile phone, wherein the contact record includes at least: the call number, time and date of the call and the recorded short message.

According to some embodiments of the present invention the contact management application of claim 1 wherein the voice recording module is configured to record during the call upon user activation at the time of the call, maintaining only partial part of the call for predefined period before the user activated the recordation till the point in time of the activation.

According to some embodiments of the present invention the Contact management module enable to share contact record between users which have established group relations in between.

According to some embodiments of the present invention the contact management application of claim 1 wherein each contact record has a group field and or sub group field, such as all records of specific category/sub category are shared between user [symbol] which are part of predefined group.

According to some embodiments of the present invention the partial recording is implemented by recording the whole call session and tagging the time slot the user selected to record, wherein At the end of the call or later the selected time slot is extracted from the recorded call session and saved in association with record of the call and record of the contact name. The remained recorded part of the call session is deleted.

According to some embodiments of the present invention before starting the recording prompting, the user with voice or text message indicating the recording has started.

The present invention provides a contact management application, implemented on a smart phone implemented by plurality of modules comprising one or more processors, operatively coupled to non-transitory computer readable storage devices,
Call tracker module for identifying start of call;
Call management module, which is configured to be activated upon identifying start of call, enabling the user to enter text or voice message;
Contact management module for updating contact record with enter text or voice message.

The contact management application of claim 7 wherein the Call management module is further configured to define contact by determining group association during the call session.

According to some embodiments of the present invention the Call management module is further configured to define contact by determining one or more label associated with the contact or specific call during the call session.

According to some embodiments of the present invention the Call management module is further configured to enable sharing documents between groups members.

According to some embodiments of the present invention enabling to to select documents to be accessed by cloud to all group members by providing automatic authority to group member to access the selected documents

The present invention provides a contact management application, implemented on a smart phone, implemented by plurality of modules comprising one or more processors, operatively coupled to non-transitory computer readable storage devices, comprising the following modules:
Call tracker module for identifying end of call;
Voice recording module, which is configured to be activated upon identifying end of call, for recording short message by the smart phone user, wherein the recording is activated for predefined time period or upon receiving an indication from the user to end the recording;

Messages management module for creating automatically new contact record upon identifying end of call in case the call number is not in the contact list of the smart mobile phone, wherein the contact record includes at least: the call number, time and date of the call and the recorded short message.

The present invention provides a contact management application, implemented on a smart phone, implemented by modules, comprising one or more processors, operatively coupled to non-transitory computer readable storage devices, comprising the following modules:
Call tracker module for identifying end of call;
Call enrichment module, which is configured to be activated upon identifying start of call, enabling the user enter messages during the call and/or classify call by label and or assign call log to group member;

Call log management module configured to display call log, wherein for each call record is display the entered messages and/or label and or the assigned group.

According to some embodiments of the present invention in case unblown caller Name creating new contact based on recording text by identifying names or text entered during the call or after the call ended;

### DESCRIPTION OF THE DRAWINGS

FIG. 1A depicts a block diagram of the contact management system components, according to one embodiment of this invention;

FIG. 1B a block diagram of the call management systems components, according to one embodiment of this invention.

FIG. 2 depicts a flow diagram of the contact management app including call tracking module describing scenario of non-recognized call according to some embodiments of the present invention;

FIG. 3 depicts a flow diagram of the contact management app including call tracking module describing scenario of recognized call according to some embodiments of the present invention;

FIG. 4 depicts a flow diagram of the contact management app including call tracking module describing scenario driving mode of non-recognized call according to some embodiments of the present invention;

FIG. 5 depicts a flow diagram of the contact management app including call tracking module describing scenario driving mode of recognized call according to some embodiments of the present invention;

FIG. 6A depicts a flow diagram of the management of contacts according to some embodiments of the present invention;

FIG. 6B depicts a flow diagram of the management of contacts according to some embodiments of the present invention;

FIG. 7 depicts a screen shoot example of the application showing recording option during call according to some embodiments of the present invention;

FIG. 8 depicts a screen shoot example of the application showing recording option during call according to some embodiments of the present invention;

FIG. 9 depicts a screen shoot example of the application showing recording during call according to some embodiments of the present invention;

FIG. 10 depicts a screen shoot example of the application showing sending recording during call according to some embodiments of the present invention;

FIG. 11 depicts a screen shoot example of the application showing end of call option of recording message according to some embodiments of the present invention;

FIG. 12 depicts a screen shoot example of the application showing end of call option of stop recording message according to some embodiments of the present invention;

FIG. 13 depicts a screen shoot example of the application showing management screen end of day screen according to some embodiments of the present invention;

FIG. 14 depicts a screen shoot example of the application showing list of recording according to some embodiments of the present invention;

FIG. 15 depicts a screen shoot example of the application showing list of recording according to some embodiments of the present invention;

FIG. 16 depicts a screen shoot example of the application showing list of recording according to some embodiments of the present invention;

FIG. 17 depicts a screen shoot example of the application showing list of recording by category according to some embodiments of the present invention;

FIG. 18 depicts a screen shoot example of the application showing editing of contact record according to some embodiments of the present invention;

FIG. 19 depicts a screen shoot example of the application showing setting screen according to some embodiments of the present invention;

FIG. 20 depicts a screen shoot example of the application showing setting screen according to some embodiments of the present invention;

FIG. 21 depicts a screen shoot example of the application showing setting screen according to some embodiments of the present invention;

FIG. 22 depicts a screen shoot example of the application showing setting screen according to some embodiments of the present invention;

FIG. 23 depicts a screen shoot example of the application showing invitation to team screen according to some embodiments of the present invention;

FIG. 24 depicts a screen shoot example of the application showing call recording managing screen according to some embodiments of the present invention;

FIG. 25 depicts a screen shoot example of the application contact setting screen according to some embodiments of the present invention;

FIG. 26 depicts a screen shoot example of the application showing call management screen according to some embodiments of the present invention;

FIG. 27 depicts a screen shoot example of the application showing call management screen according to some embodiments of the present invention;

FIG. 28 depicts a screen shoot example of the application showing end of call recording screen according to some embodiments of the present invention;

FIG. 29 depicts a screen shoot example of the application showing end of call log management screen according to some embodiments of the present invention;

FIG. 30 depicts a screen shoot example of the application showing pop screen during call enabling to enter text, label message and set group screen according to some embodiments of the present invention;

FIG. 31 depicts a screen shoot example of the application showing filtering screen by categories according to some embodiments of the present invention;

### DETAILED DESCRIPTION OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides unique method for managing contacts in a smartphone supporting creation of CRM database and summarizing calls content.

The present invention provides disclose call management application 100, implemented on a smart phone, implemented by plurality of modules comprising one or more processors, operatively coupled to non-transitory computer readable storage devices, comprising the following modules:
call tracker module for identifying end of call;
call enrichment module, which is configured to be activated upon identifying start of call configured for uploading a first popup screen, enabling the user enter messages during the call and/or classify call by label and/or assign call log to predefined group of users;

call log management module configured to save all information collected by the enrichment module is association with the specific call log, wherein for each call log record includes the entered messages and/or label and or the assigned group.

The present invention provides a contact management application, implemented on a smart phone, said application comprised of:
Call tracker module for identifying end of call;
Voice recording module, which is configured to be activated upon identifying end of call, for recording short message by the smart phone user, wherein the recording is activated for predefined time period or upon receiving an indication from the user to end the recording;
Contact management module for creating automatically new contact record upon identifying end of call in case the call number is not in the contact list of the smart mobile phone, wherein the contact record includes at least: the call number, time and date of the call and the recorded short message.

According to the present invention the voice recording module is configured to record during the call upon user activation at the time of the call, maintaining only partial part of the call for predefined period before the user activated the recordation till the point in time of the activation.

According to the present invention the Contact management module enable to share contact record between users which have established group relations in between.

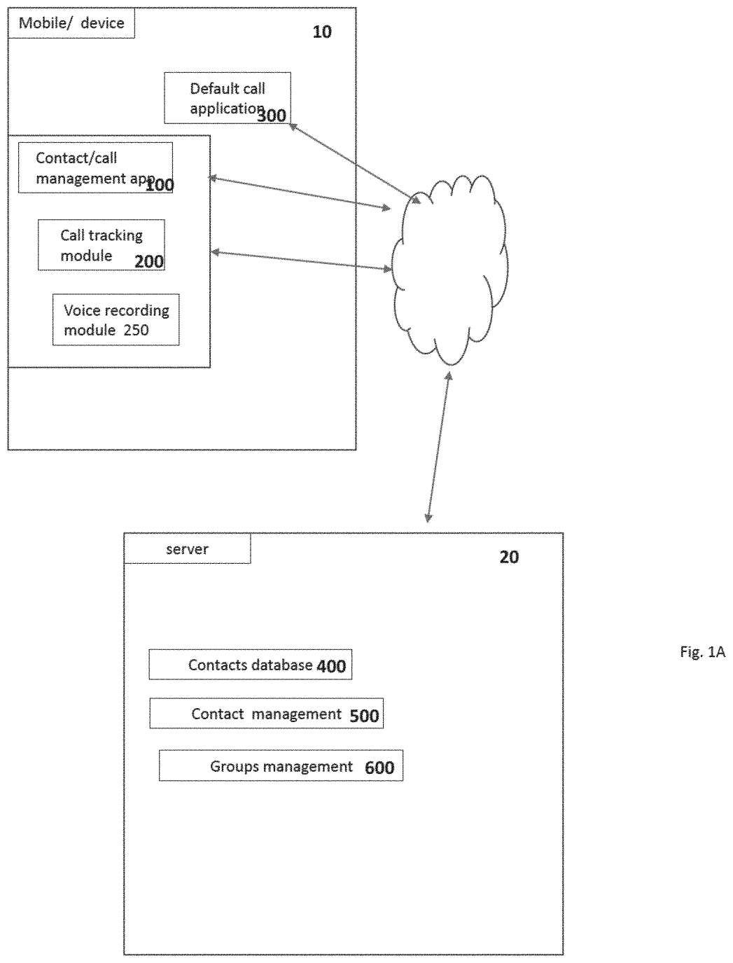

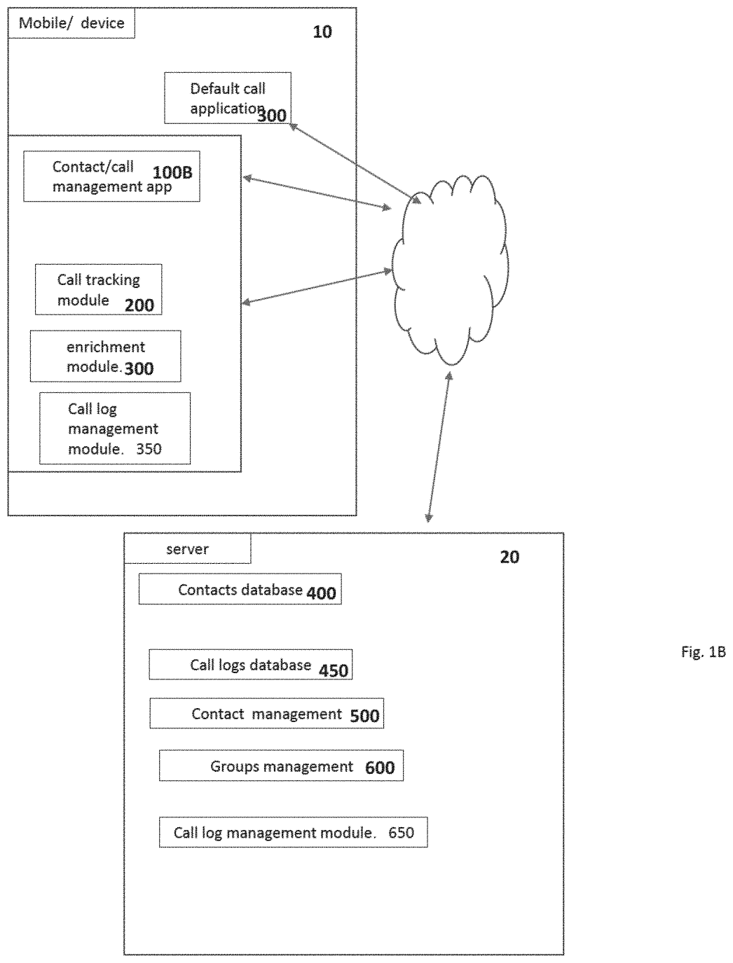

FIG. 1A depicts a block diagram of the contact management system components, according to one embodiment of this invention. The system is mainly comprised of designated call management app 100 installed on a mobile phone 10 including a call tracking module 200, contact management module 150 voice recording module 250, the call tracking module identifies when a call session is ended and automatically, activates recording session for short predefined time period enabling the user to record an audio message using the voice recording module 250. If the caller or called number are not recognized by the list of contacts of the designated calling application or the default call application of the user, at the end of the call the user is requested to record a voice message or text message and contact record is created at the temp calling contact list of the calling designated application and the recording voice message or text message are associated with new created temp contact and the record of the call. In cased the caller or called number are recognized in the by the list of contacts of the designated calling application or the default call application of the user, the recording of the voice message or the text message are associated with the record of the contact and the record of the call. When accessing the record of the contact the user can access each recorded message, view the list of all calls with the contact upon selecting specific call the user may view the associated messages of the specific call.

According to some embodiments of the present invention server 20 is comprised of contact database 400, contact management module 500 and group management module 600. The server 20 is updated by the call/contact management with the information gathered by the call management app, including text memo entered by the user, selection of labeling or groups and or voice recording. The gathered information is saved at the databases of contacts and or call logs

According to some embodiments of the present invention, the designated call application and the default call application are the same application.

According to some embodiments of the present invention, the designated call application is functioning as a caller application.

According to some embodiments of the present invention the contact management application enables the user to view all the calls received unrecognized number at the last predefined period such the last hour, last day, last week etc. The user may enter the record of each call and perform one of the following:
listen to the recording associated with the call or see the transcript of the recording if available and update the call record,
updating the name of the contact
defining the time period of maintaining the record;
defining the contact name as permanent contact and adding the contact to the permanent contact list, for example the default contact list of the user of his default calling up;
categorizing the call record by tagging or from defined list of categories;
sending recorded voice or text message to the contact name or other contact names
defining task related to the contact, setting reminders, scheduling a meeting, writing notes.

According to some embodiments of the present invention, when a recording limited time period is ending the user may receive indication the recording is ending (using voice or visual trigger) and enable the user to prolong the recording time to another predefined pre-defined time period.

According to some embodiments of the present invention, at the time of recording the user may say pre-defined terms at the beginning of the recording, such terms can automatically define a category of the new created contact record. For example, the user may say the term “spam”, and autonomically the contact name may be categorized as spam, and the user will receive indication of spam call, when receiving a call from this contact. Other example may include terms which indicate of profession of the contact: lawyer, doctor, Real Estate Broker, technician etc., the created contact name is automatically categorized by this term. These pre-defined terms may be system setting or user defined.

According to some embodiments of the present invention, the user may agree to share contact name of one or more specific category with other users, the user may be part of a team, part of a group which may defined by the user, such as friends or co-workers. For example, the contact categories with spam may be shared with all user of the application, and category of lawyer or doctor, may be shared with group of close friends. The user may share through the recording of the message, recommendation of the contact's name.

The contact management application may allow the user to define different type of groups based on relationship, such as family, close friends, work groups, educational groups, etc. For each group the user may define the type of categories, tags of contact he confirm to share. The user may define specific category for specific group. This option may be helpful when organizing new projects groups.

According to some embodiments of the present invention, the same defined group may enable to share content of text or multimedia, such as phots, video or hyperlink. The content may be share through the cloud, sharing virtual space.

According to some embodiments of the present invention, it is suggested to enable each defined group to have to real time chat between group members.

According to some embodiments of the present invention, it is suggested to enable each defined group to share search results using search engine such as Google, by sharing the keywords, relevant search for the search results. For example, if user searches with keywords, he receives automatically history of queries and search results of other group members, which previous searched the same or similar keywords.

According to some embodiments, each contact record has a group field and or sub group field, such as all records of specific category/sub category are shared between user which are part of predefined group. For example, all family member can be ne define to share all professional contacts.

### Contact Record

Name

Organization

Mobile Phone

Work phone, fax

Main category

Sub category

Group/team

Sub group

Text notes

Audio recording

Period/expiration,

According to some embodiments of the present invention, is provided categorizing procedure for existing contact names. The call application read all contact name, one after the other, with a pause enabling at the pause, to record the category by the user.

FIG. 1B a block diagram of the call management systems components, according to one embodiment of this invention. The system is mainly comprised of designated call application 100 and sever 20. The call application installed on a mobile phone 10, is comprised of a call tracking module 200, enrichment module 300 and call log management module 350. The call tracking module identifies when a call session is ended and automatically activates call enrichment module 200B. The call enrichment module 200B is configured to trigger the uploading of first popup screen upon the start of a new call. The first popup screen overrides the call screen and enable the user to write text during the call, this text is automatically saved and associated with call log record and/or the contact associated with call. The popup screen may first appear as floating button or small screen, loading the full screen upon user touching the button or by enlarging the small screen. The popup screen may include buttons for labeling and selecting a group for the specific call log record, and or the contact.

The call log management module 350 collect all information collected during or at end of the call, saving the information, in call log database on the local memory of the user phone of on the cloud.

According to some embodiments of the present invention server 20 is comprised of contact database 400, call log database 450, contact management module 500 and group management module 600. The server 20 is updated by the call/contact management with the information gathered by the call management app, including text memo entered by the user, selection of labeling or groups and or Voice recording. The gathered information is saved at databases of contacts, call logs

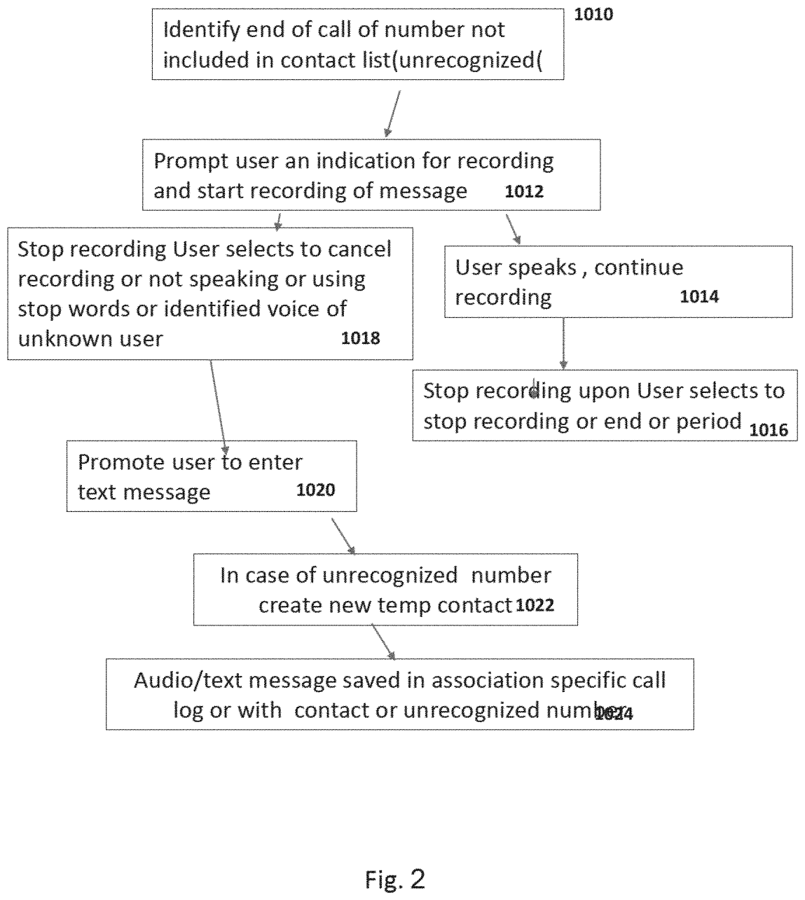

FIG. 2 depicts a flow diagram of the contact management app including call tracking module describing scenario of non-recognized call according to some embodiments of the present invention;

The modules include at least one of the followings steps:
Identify end of call of number not included in contact list (unrecognized number) (1010);
Prompt user an indication for recording and start recording of a message (1012);
User speaks, continue recording (1014);
Stop recording upon User selects to stop recording or end or period; (1016)
Optionally Stop recording User selects to cancel recording or not speaking for predefined time of period or using stop words or identified voice of unknown user for preventing recording of a third person unintentionally speaking while the recording started (1018);
In case of no voice recording Promote use to enter text message (1020)
In case of unrecognized number create new temp contact (1022);

Saving Audio or text message in association to new temp contact and/or call log (1024);

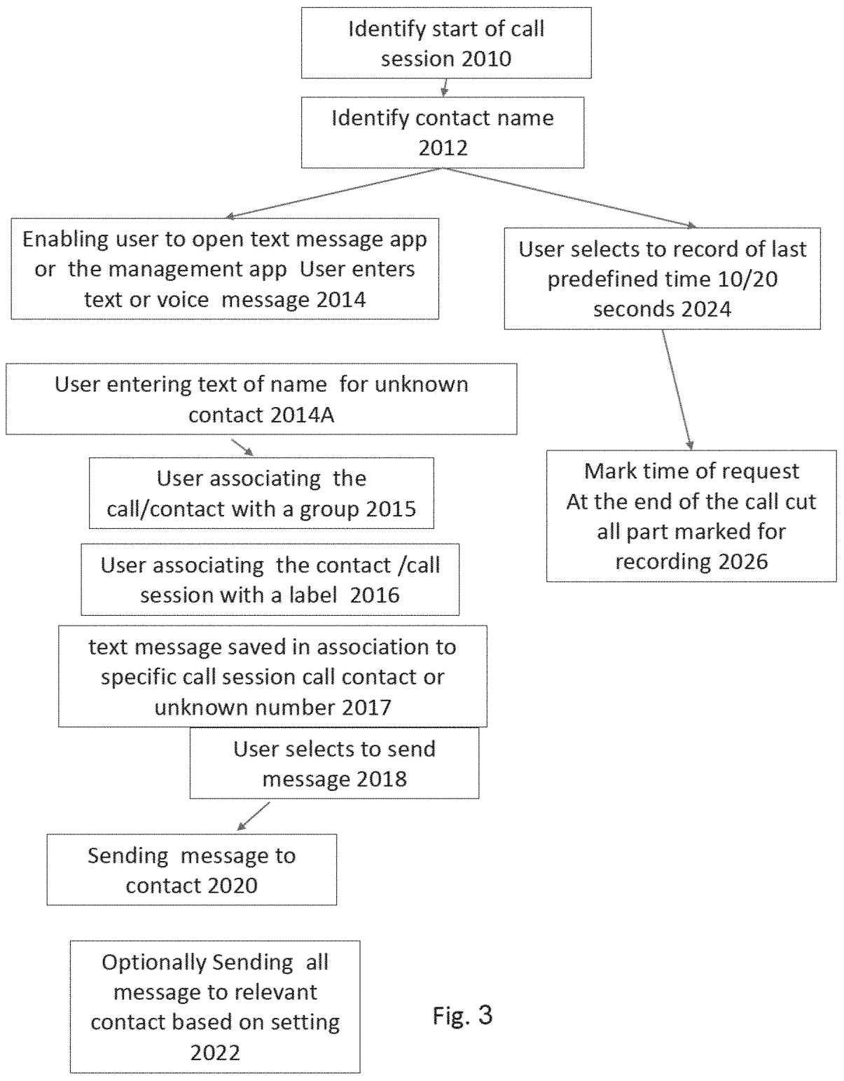

FIG. 3 depicts a flow diagram of the contact management app including call tracking module describing scenario of recognized call according to some embodiments of the present invention;
Identify start of call session 2010;
Identify contact name 2012;
First popup screen is initiated 2013, the popup screen may start with floating button appearing on the screen, upon user touching the floating button, the first popup screen appears, at any time the user may, minimize the first popup screen into smaller screen or into floating button.
User enters text or voice message 2014 using the first popup screen, optionally the user may enter text in different text box, main text box to enter his note, and small box for entering subject/keyword.
According to some embodiments, the notes may be labelled based on the entered subject or keyword. The labelling may be determined based on analysing of user keywords/subjects as written for various notes, finding common term for keywords have common context.
Name new contact with temporary name can be based on recording text by identifying names or text entered during the call or after the call ended 2104;
User entering text of name in case of unknown contact 2014A;
Optionally user select the relevant group for contact, the module associates the contact with the selected group 2015
Optionally user can a label for the call session and or contact, the module associates the contact with the selected group 2016;
Optionally labels can be determined based on user profile, requirement, creating label for his adapted for the profession, smart bot may assist the user to determine the most relevant labels.
text or voice message saved in association to contact or unknown number 2017
User selects to send recorded message 2018;
Sending recorded message to contact 2020;
Optionally Sending all message to relevant contact based on setting 2022.
Optionally enabling user to activate record of last predefined time 10/20 seconds 2024. This feature is implemented in the by recording the whole call session and tagging the time slot the user selected to record. At the end of the call or later the selected time slot is extracted from the recorded call session and saved in association with record of the call and record of the contact name. The remained recorded part of the call session is deleted.

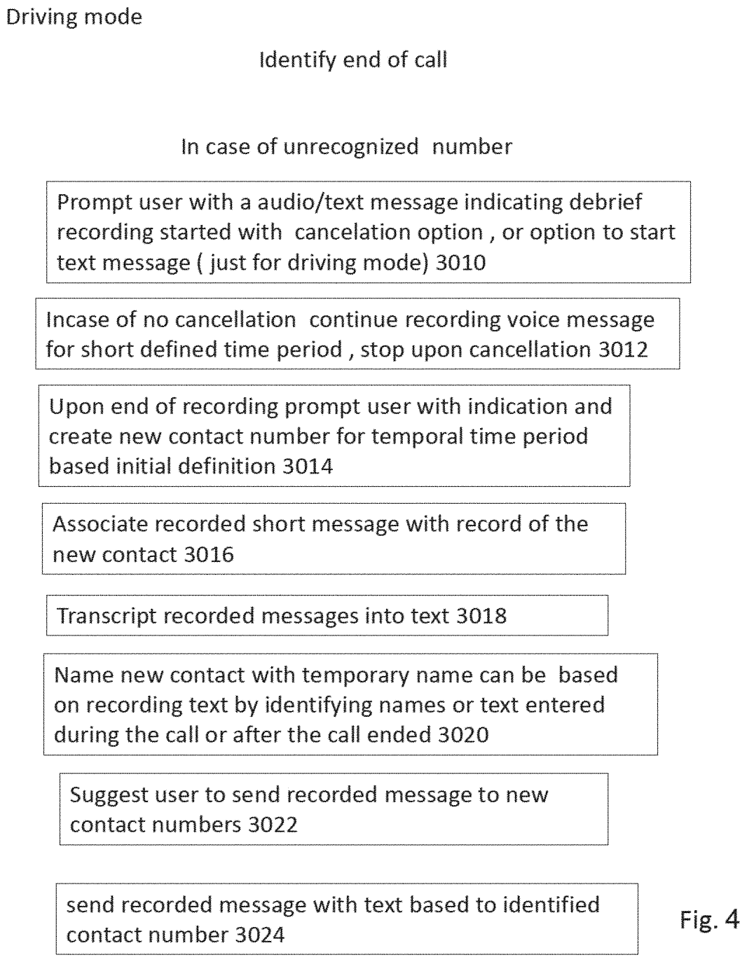

FIG. 4 depicts a flow diagram of the contact management app including call tracking module describing scenario driving mode of non-recognized call according to some embodiments of the present invention;
When identifying end of call, perform at least one or more of the followings steps:
In case of unrecognized number, Prompt user with an audio/text message indicating debrief recording started with cancelation option, or option to start text message 3010;
In case of no cancellation continue recording voice message for short defined time period, stop upon cancellation 3012;
Upon end of recording prompt user with indication and create new contact number for temporal time period based initial definition 3014;
Associate recorded short message with record of the new contact 3016;
Optionally Transcript recorded messages into text 3018;
Name new contact with temporary name can be based on recording text by identifying names or text entered during the call or after the call ended 3020;
Suggest user to send recorded message to new temp contact numbers 3022;
In case of approval send recorded message with text based to identified contact number 3024;

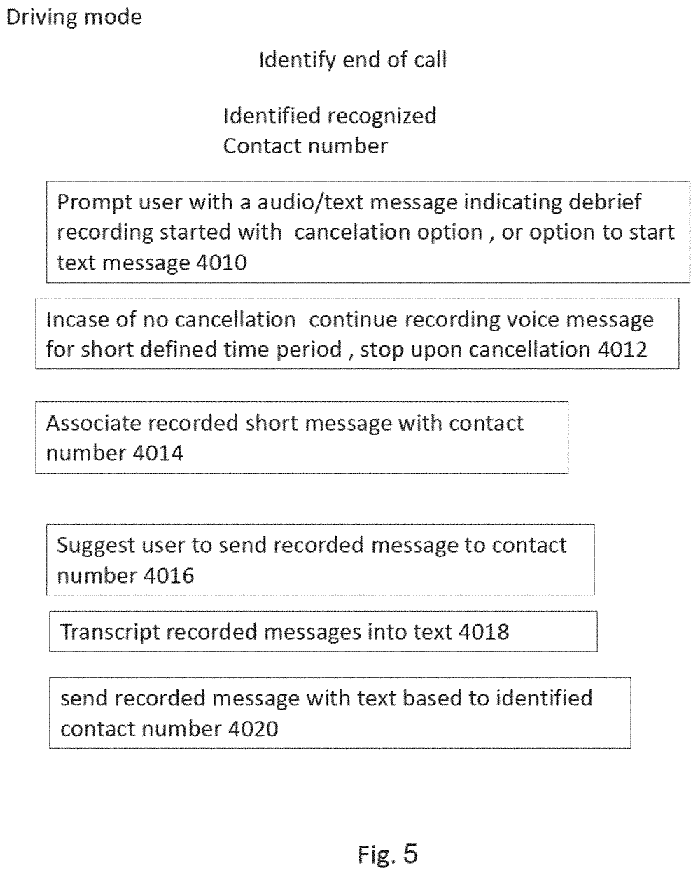

FIG. 5 depicts a flow diagram of the contact management app including call tracking module describing scenario driving mode of recognized call according to some embodiments of the present invention;
Prompt user with an audio/text message indicating debrief recording started with cancelation option, or option to start text message 4010;
In case of no cancellation continue recording voice message for short defined time period, stop upon cancellation 4012;
Associate recorded short message with contact number 4014;
Suggest user to send recorded message to contact number 4016;
Transcript recorded messages into text 4018;
send recorded message with text based to identified contact number 4020.

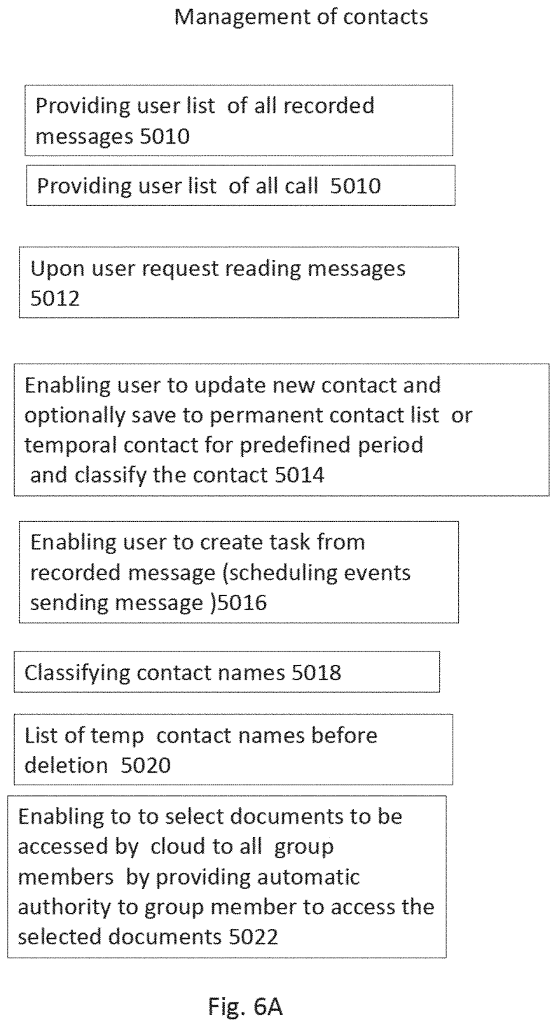

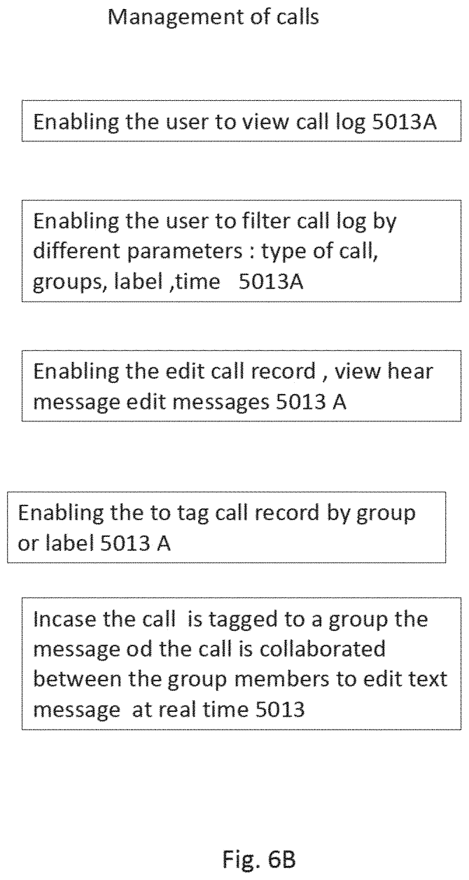

FIG. 6A depicts a flow diagram of the contact management app including call tracking module describing scenario driving mode of recognized call according to some embodiments of the present invention;
Providing user list of all recorded messages 5010
Upon user request reading messages 5012
Enabling user to update new contact and optionally save to permanent contact list or temporal contact for predefined period and classify the contact 5014
Enabling user to create task from recorded message (scheduling events sending message)5016
Classifying contact names 5018
List of temp contact names before deletion 5020
Enabling to select documents to be accessed by cloud to all group members by providing automatic authority to group member to access the selected documents, optionally using google docs 5022;

FIG. 6B depicts a flow diagram of the management of contacts according to some embodiments of the present invention;
Enabling the user to view call log 6012;
Enabling the user to filter call log by different parameters: type of call, groups, label 6014;
Enabling the edit call record, view hear message edit messages 6016;
Enabling them to tag call record by group or label 6018;
In case the message is tagged to a group the message is in online collaboration with the other group members 6020;
According to some embodiments of the present invention group of users having installed the contacts management application can shared the records of the new contact with the associated recording. For example, sale company having plurality of workers, may register all worker as at least one group or sub groups enabling each worker or manager access to other workers records of contact name and call records with associated recorded messages. The access may be limited based on define access rights, enabling different access to different manger or workers, based on the role of the worker. An organization may define more than one group and define association and hierarchy between groups and between members of the group, the hierarchy may define the access rights of each group member.
   According to some embodiments of the present invention the user may edit each contact record, determining time period for maintaining the record, after which the record will be deleted. The editing may include determining category of the contact name.
   According to some embodiments of the present invention, the end of call may be end of regular phone call, through the cellular network or voice/video over IP call (such as skype, zoom etc.), based on data communication network, such as the Internet.
   According to some embodiments of the present invention, an automatic activation of voice recording can be triggered by different type of events, which can be identified through actions of any application on the mobile phone or sensor data. For example, when arriving or living a predefined location using GPS data or performing task in in specific application.
   According to some embodiments of the present invention, the labeling and grouping can be used classify mails, each new generated or received mail, may be classified with label and/or group, enabling create unified messaging platform.

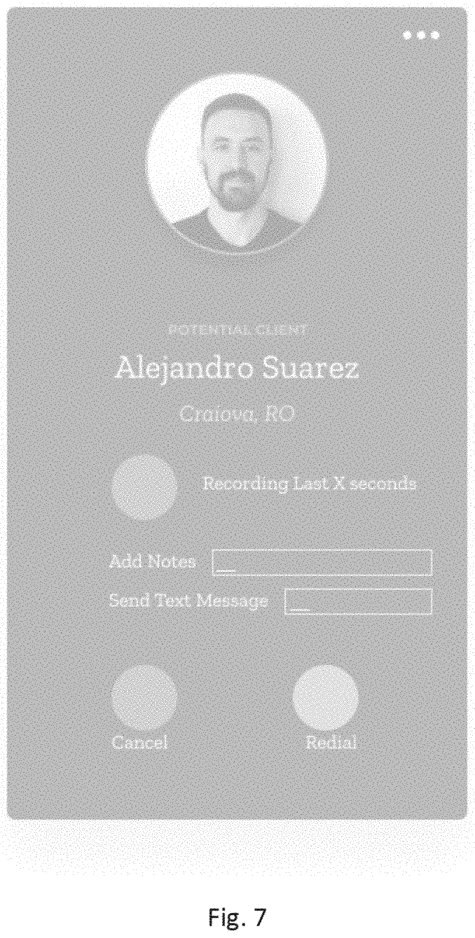

FIG. 7 depicts a screen shoot example of the application showing recording option during call according to some embodiments of the present invention;

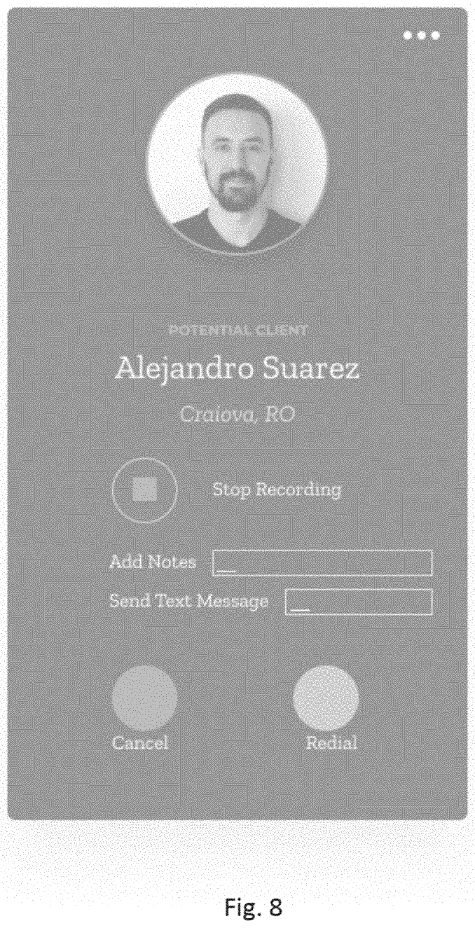

FIG. 8 depicts a screen shoot example of the application showing recording option during call according to some embodiments of the present invention;

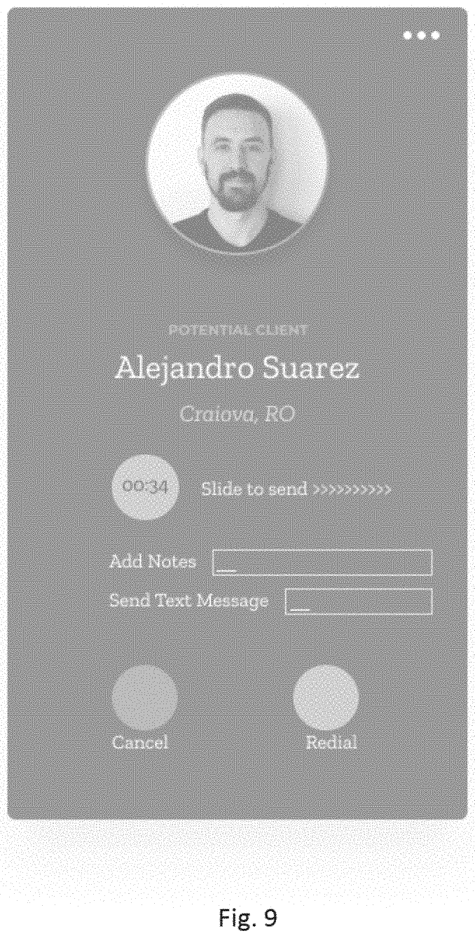

FIG. 9 depicts a screen shoot example of the application showing recording during call according to some embodiments of the present invention;

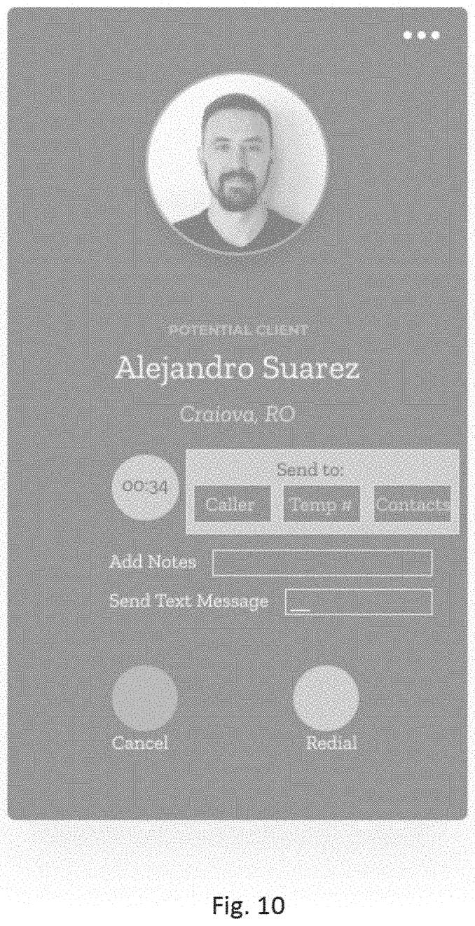

FIG. 10 depicts a screen shoot example of the application showing sending recording during call according to some embodiments of the present invention;

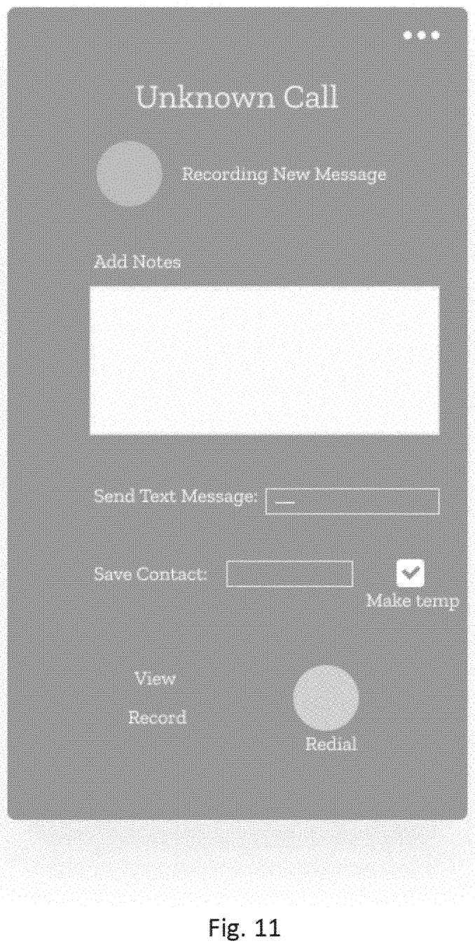

FIG. 11 depicts a screen shoot example of the application showing end of call option of recording message according to some embodiments of the present invention;

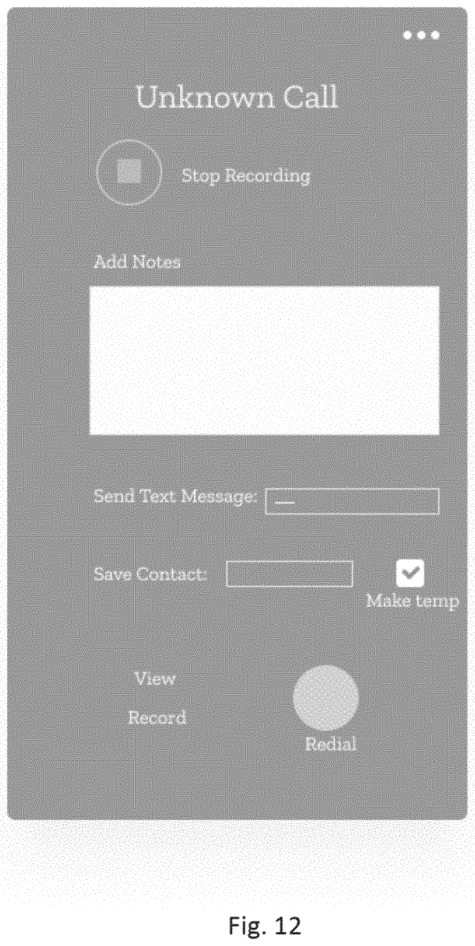

FIG. 12 depicts a screen shoot example of the application showing end of call option of stop recording message according to some embodiments of the present invention;

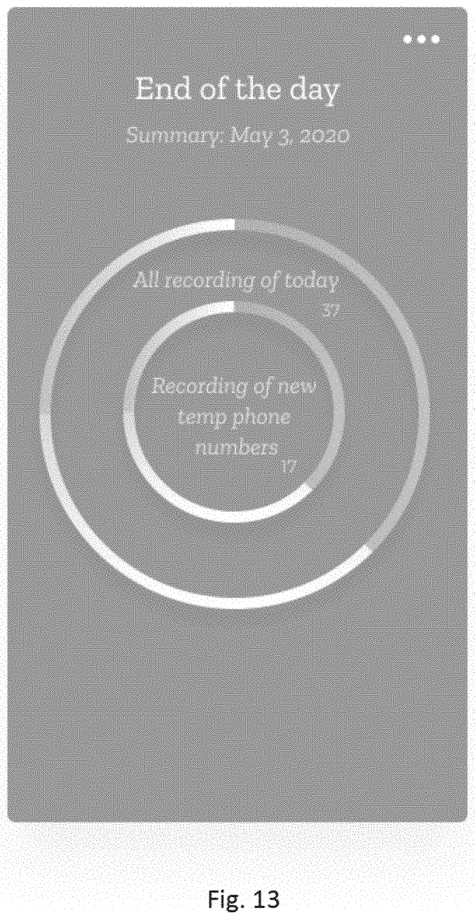

FIG. 13 depicts a screen shoot example of the application showing management screen end of day screen according to some embodiments of the present invention;

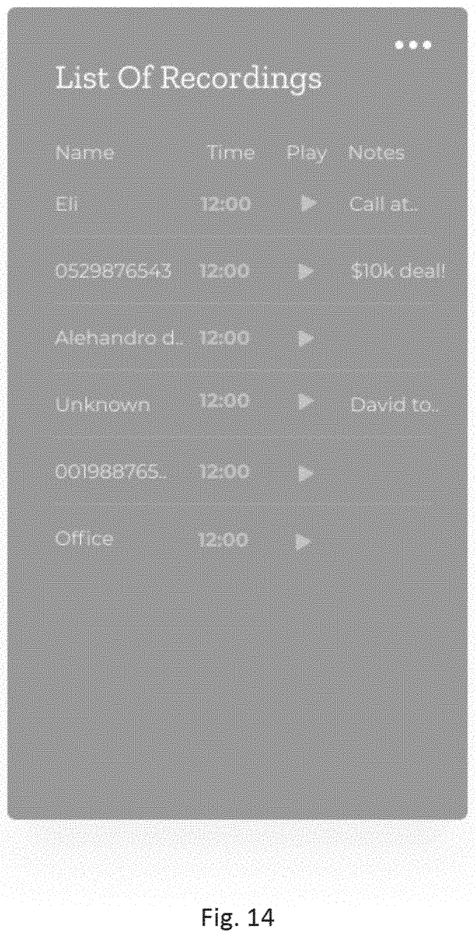

FIG. 14 depicts a screen shoot example of the application showing list of recording according to some embodiments of the present invention;

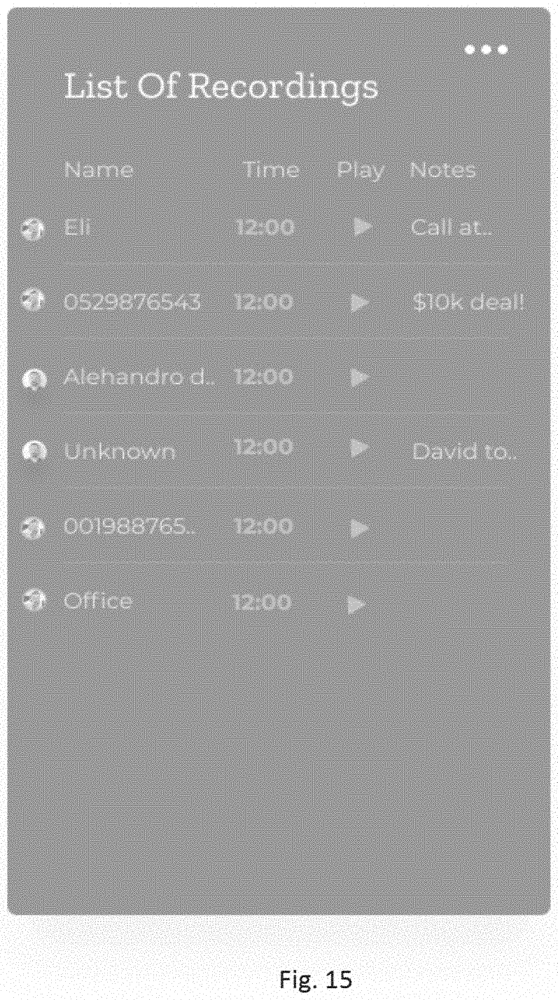

FIG. 15 depicts a screen shoot example of the application showing list of recording according to some embodiments of the present invention;

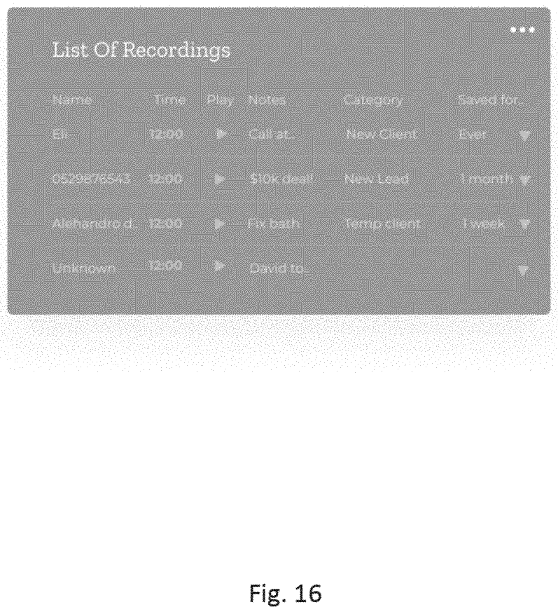

FIG. 16 depicts a screen shoot example of the application showing list of recording according to some embodiments of the present invention;

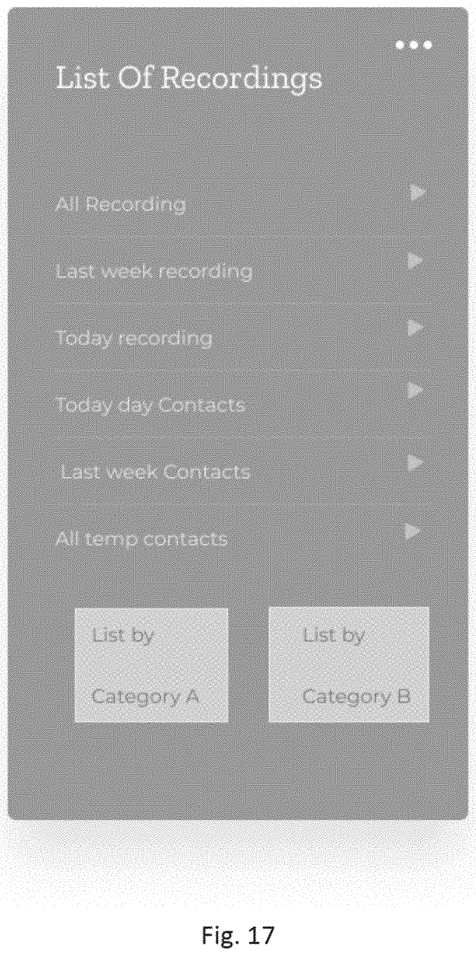

FIG. 17 depicts a screen shoot example of the application showing list of recording by category according to some embodiments of the present invention;

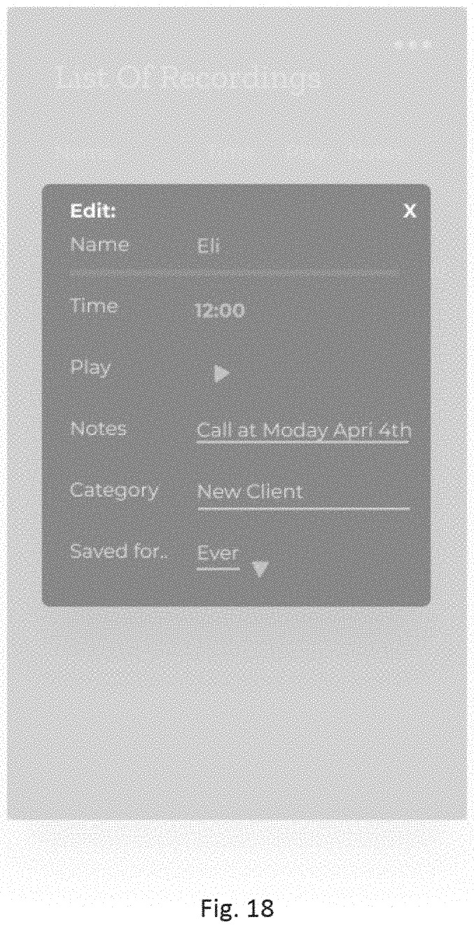

FIG. 18 depicts a screen shoot example of the application showing editing of contact record according to some embodiments of the present invention;

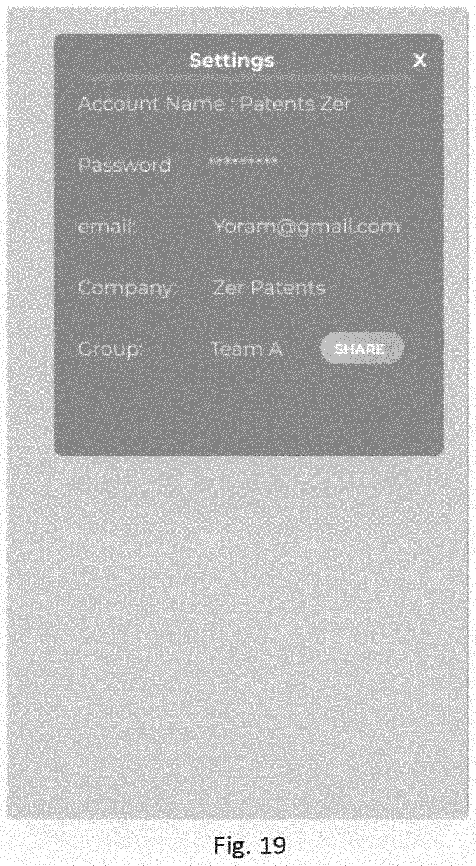

FIG. 19 depicts a screen shoot example of the application showing setting screen according to some embodiments of the present invention;

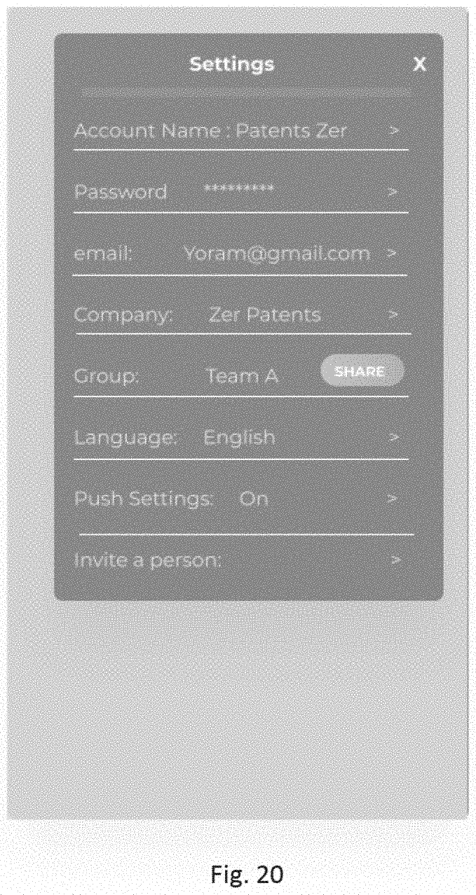

FIG. 20 depicts a screen shoot example of the application showing setting screen according to some embodiments of the present invention;

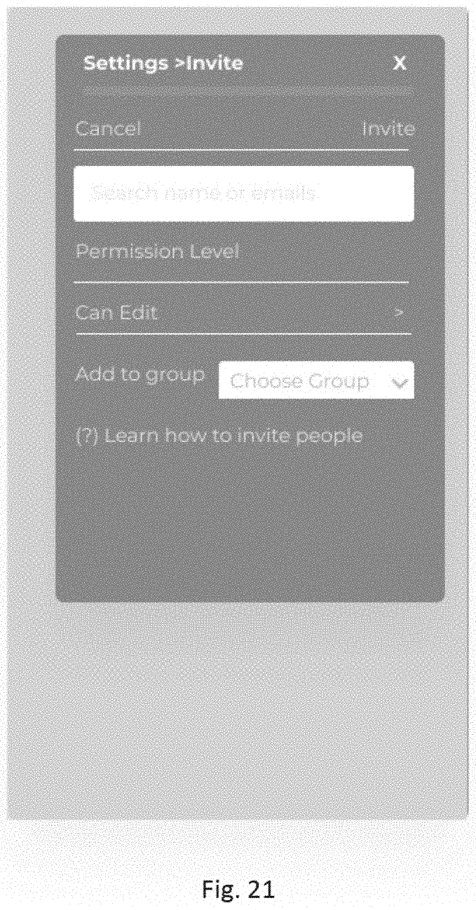

FIG. 21 depicts a screen shoot example of the application showing setting screen according to some embodiments of the present invention;

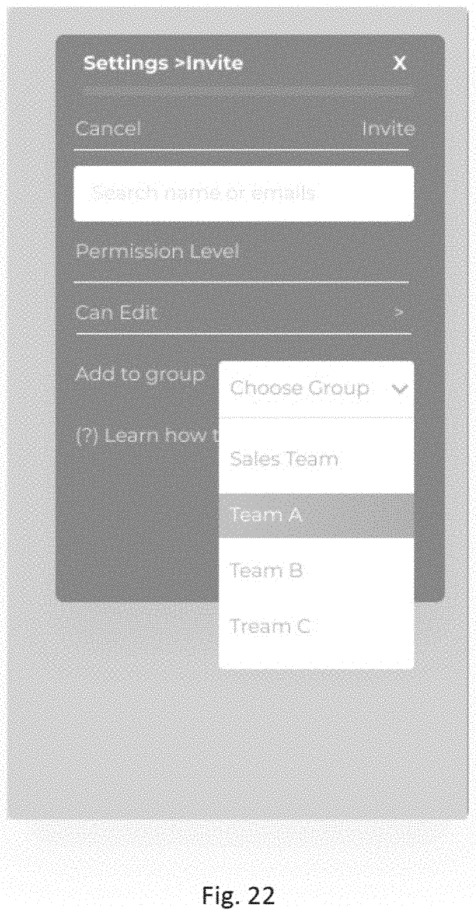

FIG. 22 depicts a screen shoot example of the application showing setting screen according to some embodiments of the present invention;

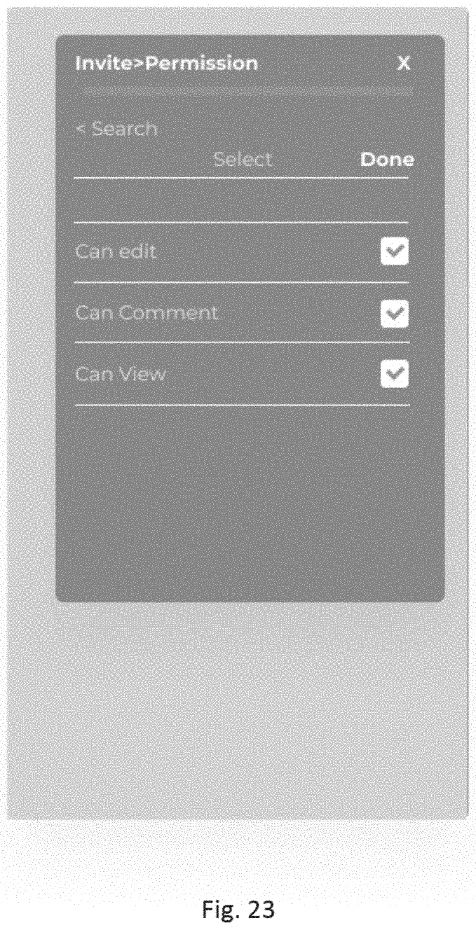

FIG. 23 depicts a screen shoot example of the application showing invitation to team screen according to some embodiments of the present invention;

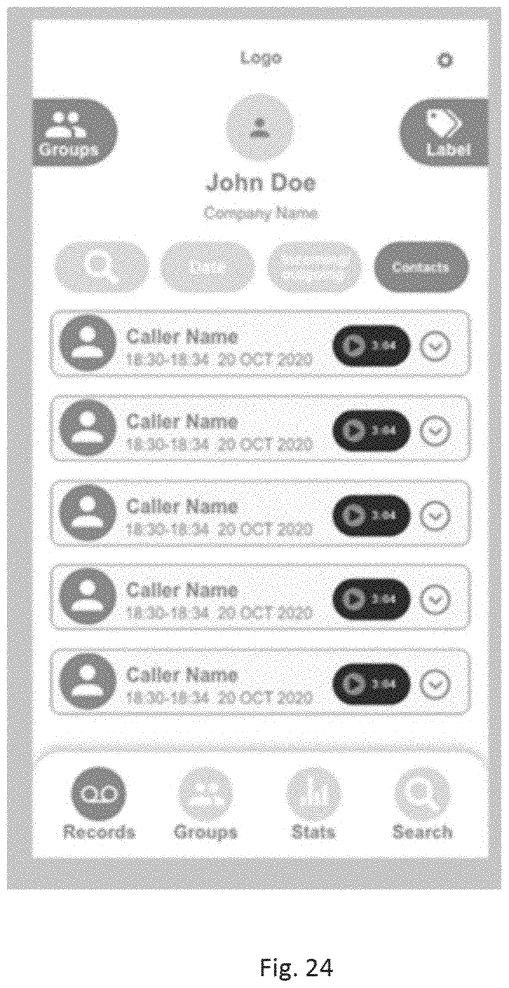

FIG. 24 depicts a screen shoot example of the application showing call recording managing screen according to some embodiments of the present invention. The management screen enables to filter call recording log, based on date, contact, group, label;

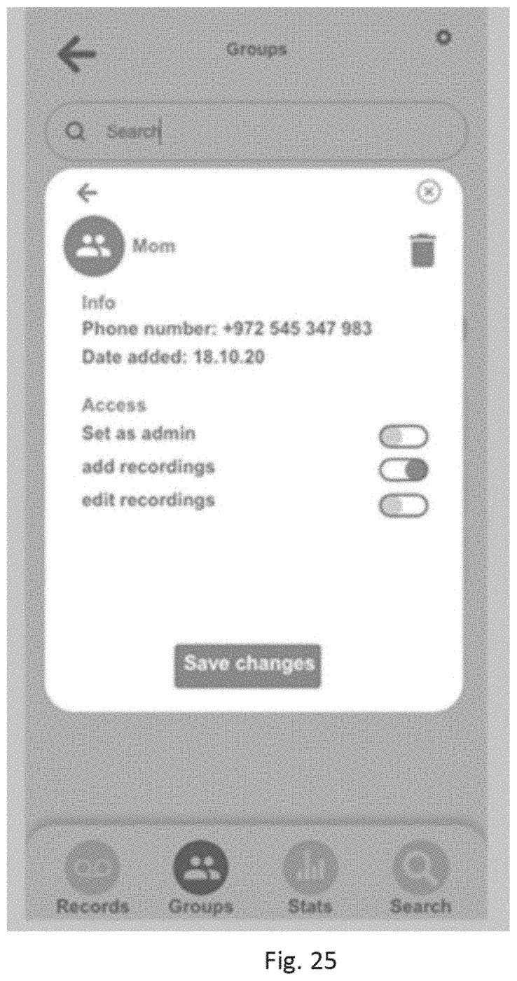

FIG. 25 depicts a screen shoot example of the application contact setting screen according to some embodiments of the present invention. Enabling to update which contact can make recording, edit recording

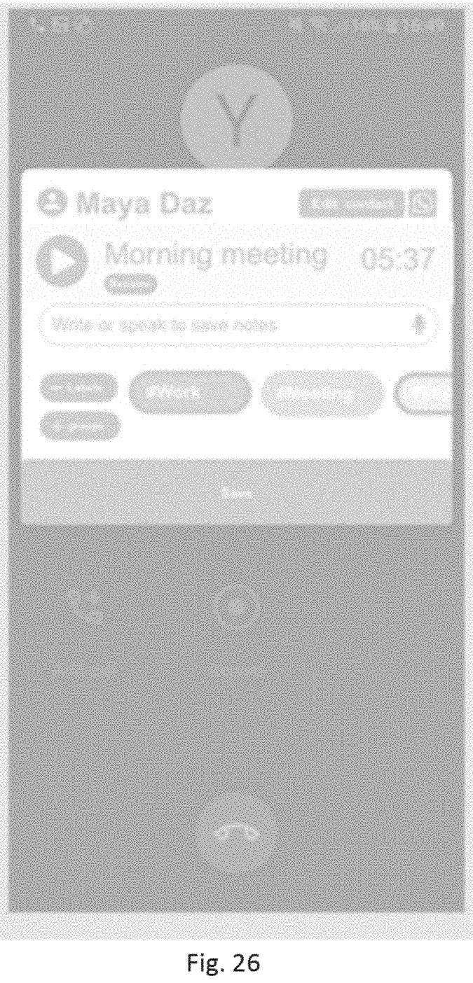

FIG. 26 depicts a screen shoot example of the application showing call management screen according to some embodiments of the present invention;

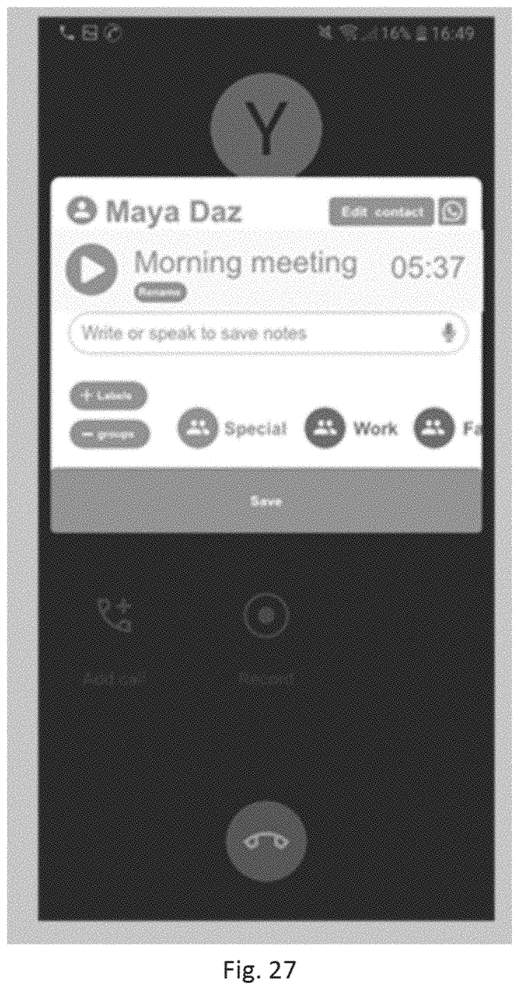

FIG. 27 depicts a screen shoot example of the application showing call management screen according to some embodiments of the present invention;

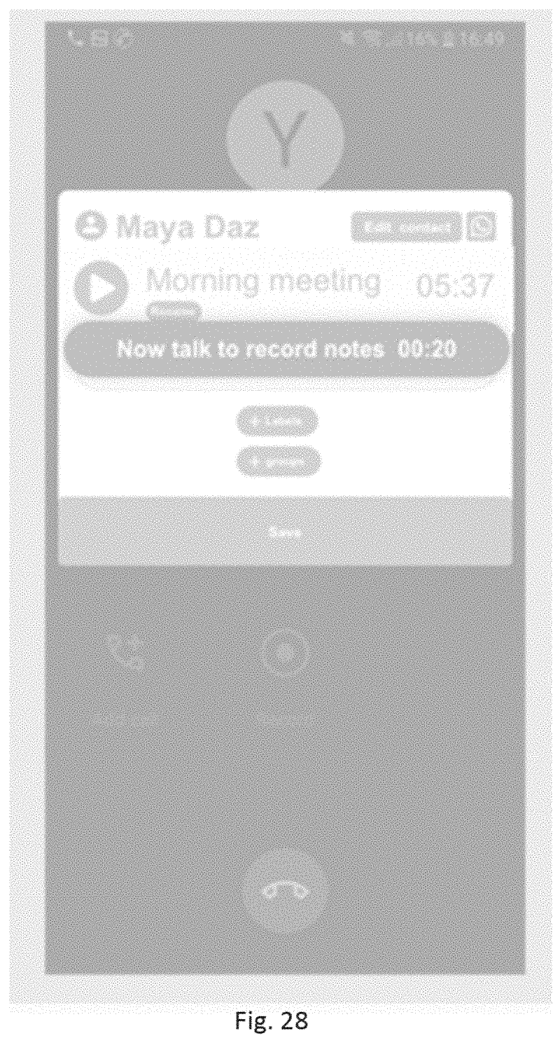

FIG. 28 depicts a screen shoot example of the application showing end of call recording screen according to some embodiments of the present invention;

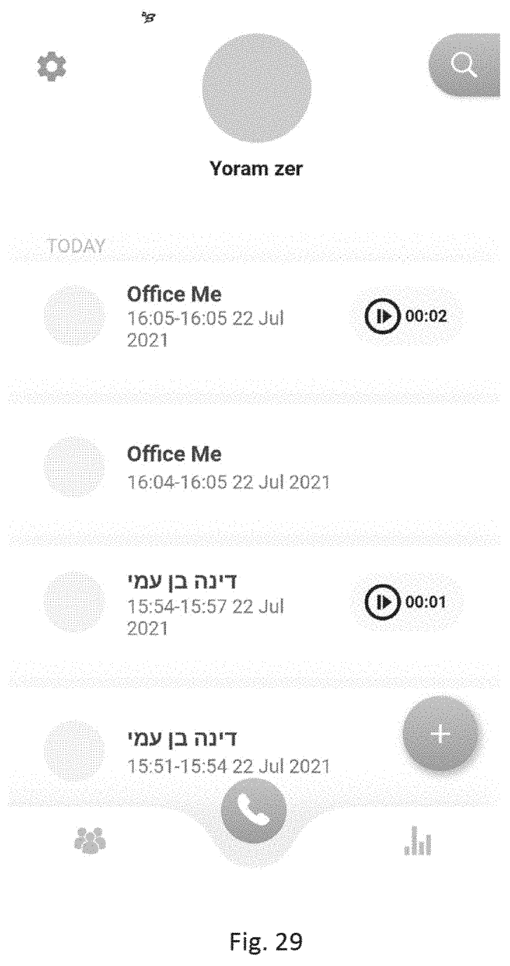

FIG. 29 depicts a screen shoot example of the application showing end of call log management screen according to some embodiments of the present invention;

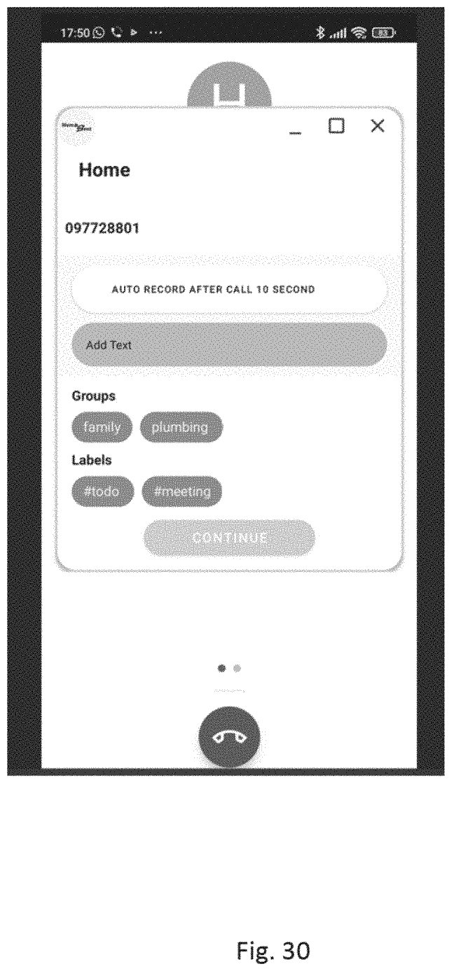

FIG. 30 depicts a screen shoot example of the application showing pop screen during call enabling to enter text, label message and set group screen according to some embodiments of the present invention;

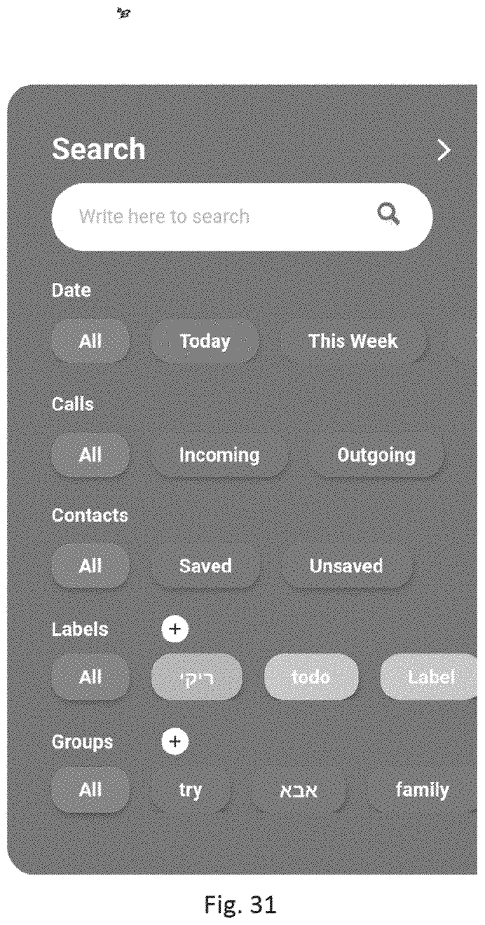

FIG. 31 depicts a screen shoot example of the application showing filtering screen by categories according to some embodiments of the present invention.
The system of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitably operate on signals representative of physical objects or substances.
Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.
The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.
It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.
Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.
Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.
The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.
Features of the present invention which are described in the context of separate embodiments may also be provided in combination in a single embodiment.
For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A call management application, implemented on a smart phone, implemented by plurality of modules comprising one or more processors, operatively coupled to non-transitory computer readable storage devices, comprising the following modules:
call tracker module for identifying end of call;
call enrichment module, which is configured to be activated upon identifying start of call configured for uploading a first popup screen, enabling the user enter messages during the call and/or classify call by label and/or assign call log to predefined group of users;
call log management module configured to save all information collected by the enrichment module is association with the specific call log, wherein for each call log record includes the entered messages and/or label and or the assigned group.

2. The call management application of claim 1 wherein the contact management module enables to share contact record between users which have established group relations in between.

3. The call management application of claim 1 wherein each contact record has a group field and or sub group field, such as all records of specific category/sub category are shared between users which are part of predefined group.

4. A contact management application, implemented by plurality of modules comprising one or more processors, operatively coupled to non-transitory computer readable storage devices,
Call tracker module for identifying end of call;
Voice or text recording module, which is configured to be activated upon identifying end of call, for recording short message by the user, wherein the recording is activated for predefined time period or upon receiving an indication from the user to end the recording;
Contact management module for creating automatically new contact record upon identifying end of call in case the call number is not in the contact list of the smart mobile phone wherein the contact record name is based on the recorded message and include at least: the caller number, time and date of the call and the recorded short message.

5. The contact management application of claim 4 wherein the voice recording module is configured to record during the call upon user activation at the time of the call, maintaining only partial part of the call for predefined period before the user activated the recordation till the point in time of the activation.

6. The contact management application of claim 5 wherein the partial recording is implemented by recording the whole call session and tagging the time slot the user selected to record, wherein At the end of the call or later the selected time slat is extracted from the recorded call session and saved in association with record of the call and record of the contact name.

7. The contact management application of claim 4 wherein before starting the recording prompting, the user with voice or text message indicating the recording has started.

8. A call management application, implemented on a smart phone, by plurality of modules comprising one or more processors, operatively coupled to non-transitory computer readable storage devices:
call tracker module for identifying start of call;
call management module, which is configured to be activated upon identifying start of call, enabling the user to enter text or voice message #;
contact management module for updating call log or contact record with entered text or voice message.

9. The call management application of claim 7 wherein the Call management module is further configured to define contact by determining group association during the call session.

10. The call management application of claim 7 wherein the Call management module is further configured to define contact by determining one or more label associated with the contact or specific call during the call session.

11. The call management application of claim 7 wherein the Call management module is further configured to enable sharing documents between groups members.

12. The call management application of claim 1 further configured to select documents to be accessed by cloud database to all group members by providing automatic authority to group member to access the selected documents

13. The contact management application, of claim 13 wherein in case of unknown caller name creating new contact based on recording text by identifying names or text entered during the call or after the call ended.
